(19) United States
(12) Patent Application Publication
(10) Pub. No.: US 2009/0037850 A1
(43) Pub. Date: Feb. 5, 2009

(54) POLYGONAL AREA DESIGN RULE CORRECTION METHOD FOR VLSI LAYOUTS

(76) Inventors: Michael S. Gray, Fairfax, VT (US); Matthew T. Guzowski, Essex, VT (US); Jason D. Hibbeler, Williston, VT (US); Robert F. Walker, St. George, VT (US); Xin Yuan, Williston, VT (US)

Correspondence Address: SCULLY, SCOTT, MURPHY & PRESSER, P.C., 400 GARDEN CITY PLAZA, Suite 300, GARDEN CITY, NY, 11530, US

(21) Appl. No.: 11/831,990

(22) Filed: Aug. 1, 2007

(51) Int. Cl. G06F 17/50

(52) U.S. Cl. 716/2

(57) ABSTRACT

A method of polygonal area design rule correction for use in an electronic design automation tool for governing integrated circuit (IC) design layouts using one-dimensional (1-D) optimization, with steps of analyzing IC design layout data to identify violating polygons, partitioning violating polygons into rectangles in a direction of optimization, formulating an area constraint for each violating polygon to formulate a global linear programming (LP) problem that includes each constraint for each violating polygon and solving the global LP problem to obtain a real-valued solution. A next LP problem is created for each area constraint, and solved. The creating a next and solving the next LP problem and solving are repeated until the last “next LP problem” is solved using constraints and objectives representing sums or differences of no more than two optimization variables.

### BACKGROUND OF THE INVENTION

The present invention relates generally to very large scale integrated (VLSI) circuit design, and more particularly relates to an electronic design automation method, and system that implements the method for optimizing a VLSI design, and VLSI design modifications using polygonal area design rule correction.

Characteristics of today's complex very large scale integrated (VLSI) circuit designs have made accelerated processing of graphical design data an essential part of design-to-silicon processes. To achieve profitability, design houses and fabs alike must be capable of processing huge and complicated volumes of design data swiftly. As VLSI technology continues to miniaturize, support hardware and application programs required to reliably print the minimum feature sizes on silicon tend to lag behind technological advancements, further widening sub-wavelength gaps. Such support hardware and application programs, e.g., electronic design automation (EDA) tools and applications, subject VLSI circuit designs and layouts to complex rules governing, among other things, geometry of shapes on process layers comprising the layout.

The complex rules, or design rules, may include without limitation width requirements, spacing requirements, overlap requirements, etc., which should not be violated. Design rules are a series of parameters provided by semiconductor manufacturers that enable the designer to verify the correctness of his/her schematic and/or mask set, and are particular to a specific semiconductor manufacturing process. The prime objective for the application of such complex design rules is a “minimizing” of areas within a VLSI design or layout. But the application of such VLSI design rules may inadvertently disrupt the automatic or automated design layout, to greater or lesser degrees. Critical alignments, inter-net spacing, symmetries, power, performance, etc., are design specifics that can be easily lost in an automated design layout, e.g., compaction process.

Compliance with such complex design rules is very important to chip functionality and manufacturability. For that matter, many conventional EDA tools and processes are used not only to create, but also to alter or modify VLSI layouts and designs. For example, U.S. Pat. No. 6,189,132 discloses a design rule correction system and method; U.S. Pat. No. 6,986,109 discloses a method for a VLSI design layout optimization that is hierarchical-preserving; and U.S. Pat. No. 7,062,729 discloses a system and method for obtaining feasible integer solutions from half-integer solutions in a hierarchical circuit layout optimization.

Manual layout is a conventional process known to inevitably introduce rules violations due to the difficulty of satisfying large numbers of complex design rules by hand. In the not-so-distant past, such design rule violations were generally corrected via tedious iterations between design rule checking tool runs, the manual layout modifications, and further checking and further manual layout modifications. For that matter, manual layout modification requires that object and shape locations in a VLSI design layout be represented as integers due to technology specifications.

Various tools and application programs also are known that attempt to accommodate or correct for design rule violations, for example, rules violations occurring within an EDA process operating on a modified VLSI design. Migration is an EDA process that gives rise to a very large number of design rule violations in a design or redesign. Migration transforms VLSI layouts in a first technology to a layout in a second, different technology, where the second different technology is limited to a set of design rules that are distinct from rules associated with the first technology. Migration process begins with a simple scaling of the existing (first technology) design using commercially available programs (i.e., EDA tools and applications). Non-scalable differences in the design rules result in the introduction of design rules violations, particularly rules relating to the second technology that must be corrected, typically in a tedious manual iterative process.

Related design rule violation correction techniques include U.S. Pat. No. 6,189,132 (“the '132 patent”), commonly owned and incorporated herein by reference. The '132 patent discloses a system and method for automatically correcting design rule violations. To do so, the '132 patented invention modifies a layout of a plurality of objects in accordance with a plurality of predetermined criteria, or design rules. The '132 patent implements the modifications by first defining an objective function for measuring a location perturbation and a separation perturbation in the layout. A linear system is then defined using linear constraints. The intended objective is to describe separations between layout objects. The linear system is solved simultaneously to remove violations of the design rules, and modify shapes and object positions in the modified layout based on the solution of the linear system. The '132 patent does not, however, address the layout in a way that preserves design hierarchy, nor correct maximum area violations.

U.S. Pat. No. 6,587,992 (“the '992 patent”) discloses a system and method for compacting design layouts in two dimensions simultaneously, without dependence on known expansive methods such as “Branch and Bound”. The '992 patent mentions constraining a minimum area of layout shapes during two-dimensional compaction by modeling areas as a linear function of perimeter. The disclosed '992 patented method, however, only looks to constrain minimum areas of rectangular layout shapes, and makes no mention of correcting for minimum and maximum area violations.

U.S. Pat. No. 6,892,368 (“the '368 patent”) discloses an automated patching technique to correct or optimize rules violations in order to simplify and automate design layouts. The '368 patented technique includes creating “patches” of metal to correct minimum area design rule violations. Predetermined oriented patches are placed over violating regions in the layout. If the patch does not violate any other design rules, it is converted to the metal layer and added to the layout. The use of patches, however, does not handle/preserve design hierarchy. Patches only correct minimum area violations, and not maximum area violations, and may modify existing geometries.

In view of the shortcomings of conventional EDA tools and applications that support VLSI circuit design processes, it would be desirable to have automated design rule correction function, as a stand-alone EDA tool, or part of an existing EDA tool that overcomes the shortcomings in conventional VLSI compaction tools and processes.

### SUMMARY OF THE INVENTION

To that end, the present invention includes a method for polygonal area design rule correction for use in an electronic design automation tool for governing integrated circuit (IC) design layouts using one-dimensional (1-D) optimization. The method includes analyzing IC design layout data to identify violating polygons, partitioning the violating polygons into rectangles in a direction of optimization, computing an area ratio, building linear programming (LP) constraints for each of the rectangles using the area ratio and partitioned rectangle distances and solving an LP problem comprising the LP constraints.

In an alternative embodiment, the invention includes a method of polygonal area design rule correction for use in an electronic design automation tool for governing integrated circuit (IC) design layouts using one-dimensional (1-D) optimization, with steps of analyzing IC design layout data to identify violating polygons, partitioning violating polygons into rectangles in a direction of optimization, formulating an area constraint for each violating polygon to formulate a global linear programming (LP) problem that includes each constraint for each violating polygon and solving the global LP problem to obtain a real-valued solution.

The method may include creating a next LP problem for each area constraint in the real-valued solution, solving the next LP problem and repeating the steps of creating a next and solving the next LP problem until the last next LP problem solved comprises constraints and objectives representing sums or differences of no more than two optimization variables. And the method may include converting non-integers to integers where necessary, to replace one of the difference terms with an integer constant and adding a new constraint row in which the row's left hand side includes the difference term replaced with said integer constant, where the row's right hand side is the integer constant. In addition, the invention includes solving for remaining difference terms in each area constraint having two optimization variables, and using a ceiling of the right hand side where the constraint is minimum area or the floor of the right hand side if the constraint is maximum area, and creating and solving a final LP problem to obtain a half-integer solution.

The method may further include that the step of partitioning includes proportionally adjusting an edge distance of each rectangle by the same ratio in order that the total area of the offending polygons and shapes meet a minimum area rule. For that matter, the LP program structure is reduced to two variables, whereby a half-integer solution is realized, and an original hierarchy of the VLSI design layout is maintained.

The invention further includes a system for optimizing a very large scale integrated (VLSI) circuit design layout that implements an orthogonal polygonal area design rule correcting function for solving maximum/minimum polygonal area violations. The system includes means for receiving a set of data comprising the VLSI circuit design layout, means for identifying polygonal design rule violations in the design layout wherein physical layout edges are represented as variables and means for partitioning identified violating polygons into rectangles in a direction of optimization in the layout, which partitioning includes proportionally adjusting edge distances of each rectangle by a calculated fixed ratio in order that a total area of the offending polygons and shapes meet a minimum area rule, means for generating a linear programming (LP) problem structure comprising a set of constraints modeled on design rules in accordance with a calculated ratio of desired polygonal area to measured polygonal area and means for solving the LP problem to realize half-integer solutions. The means for generating preferably provides that the LP constraints are generated for each rectangle using the minimum area ratio and measured distances between the rectangles in order to ensure half-integer solutions to the LP problem generated and solved to realize half-integer solutions.

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 depicts two adjacent objects (or layout shapes) in a VLSI design layout, and depicts the various design rules and edge variables for a novel linear programming (LP) constraint formulation that reflects the shapes, design rules and edge variables;

FIG. 2 depicts a violating polygon partitioned into rectangles in an optimization direction, such that the total area of the violating polygon meets the minimum area rule in accordance with the inventive method;

FIG. 3 depicts the violating and partitioned polygon of FIG. 2 in relation to its neighboring shapes in the VLSI design layout, and the constraints required by implementation of the inventive method;

FIG. 4 depicts a violating polygonal shape or object of a VLSI design layout that is operated upon by an alternative method of the invention, where edges of the polygon are used as variables;

FIG. 5 depicts the violating polygon depicted in FIG. 4 in relation to its neighboring shapes in the VLSI design layout, and the constraints required by implementation of a global optimization by the inventive method;

FIG. 6 is a representation of a general purpose computer into which has been provided a set of computer instructions for implementing the inventive method; and

FIG. 7 is a flow chart of one embodiment of a method for implementing the present invention on a VLSI design.

### DETAILED DESCRIPTION OF THE INVENTION

The inventive method and system set forth and described herein corrects for design rules violations in VLSI design layout modifications, migrations, compactions, etc. The figures and descriptions, however, are intended only as examples, are not exclusive, and should not be interpreted to limit the scope of the invention in any way. The invention is directed to VLSI circuit design processes and automatic design rule correction that includes first finding design rule violations, and then automatically correcting or modifying the design layout to accommodate, correct for, or obviate the design rule violations.

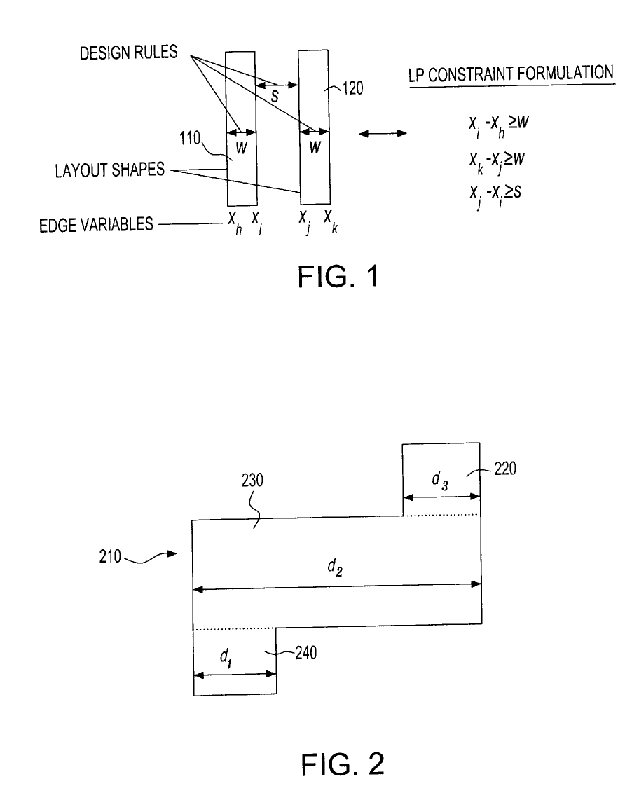

The inventive method operates in accordance with constraint-based legalization. For example, a first method embodiment corrects for minimum/maximum polygonal area violations while concurrently correcting or preventing most other design rule violation types arising in a migration or compaction process. The physical layout edges are represented as variables, and the design rules are modeled as constraint rows in a linear programming problem. For example, FIG. 1 herein depicts two design layout shapes 110 and 120, respectively, which have constrained widths (W), and interspacing (S). Such constraints are the design rules. Design layout shape edge variables Xₕ, Xᵢ, Xⱼ and Xₖ define the physical location of the shapes in the design layout. To the right in FIG. 1, the linear program (LP) constraint formulation identifies or quantifies the constraints mathematically, with respect to the FIG. 1 portion of the design layout. That is, xᵢ−xₕ must be greater than or equal to the width (W), and xⱼ−xᵢ must be greater than or equal to “S,” the interspacing between object shapes (polygons).

To implement the inventive method for a layout modification, layout locations must be represented as integers due to technology specifications. The invention requires constraint equations of the following form to guarantee a half-integer solution for a design layout:

±xᵢ, ±xⱼ≧D.

In one approach, the invention first “roughly” adjusts each portion of a polygon, e.g., shapes 110 and 120, proportionally. This “rough” adjusting includes scaling the polygon in an “optimization direction,” in order to satisfy an “area rule” (to be explained in greater detail below). The intended result of this first approach is to correct and/or constrain minimum and maximum polygonal area during automated design process (by the design rules), and preserve the original hierarchy of the layout. Various benefits are realized using the novel method, including its ability to maintain the hierarchy of an original design, and the design intent, e.g., that the maximum area design constraints are managed.

FIG. 2 herein shows a polygonal shape 210 in a VLSI circuit design that has violated a design constraint and therefore would be automatically modified by the inventive method. To do so, the inventive system and method first partitions the violating polygon 210, into three sections of various widths d₁, d₂ and d₃, in the direction of optimization (the x or abscissa axis). That is, the method breaks area constraints into sub-problem constraints containing only two variables, for example, by creating pairs of opposing edges by breaking non-trivial polygons, such as polygon 210 of FIG. 2, into rectangles in an optimization direction.

The dotted lines in FIG. 2 are the partition lines generated by the invention to modify the original polygon. The modified polygon comprises three rectangles, 220, 230 and 240, defined by the dotted lines internal the polygon 210. The novel method then proportionally adjusts the edge distance of each rectangle by the same ratio such that the total area of the 2D polygon meets the minimum area rule. That is, A′ equals the desired minimum area for the offending polygon, where A is the current area. A/A′ is equal to dₙ/dₙ′, where dₙ′ is the resulting distance for rectangle n, and dₙ′=dₙA′/A. The ratio of the desired area A′ over the current area A is computed. The area ratio is then used to build the constraints for the VLSI design as a typical linear programming problem. Then the partitioned rectangular distances in the optimization direction, dₙ, must be determined, i.e., d₁, d₂ and d₃.

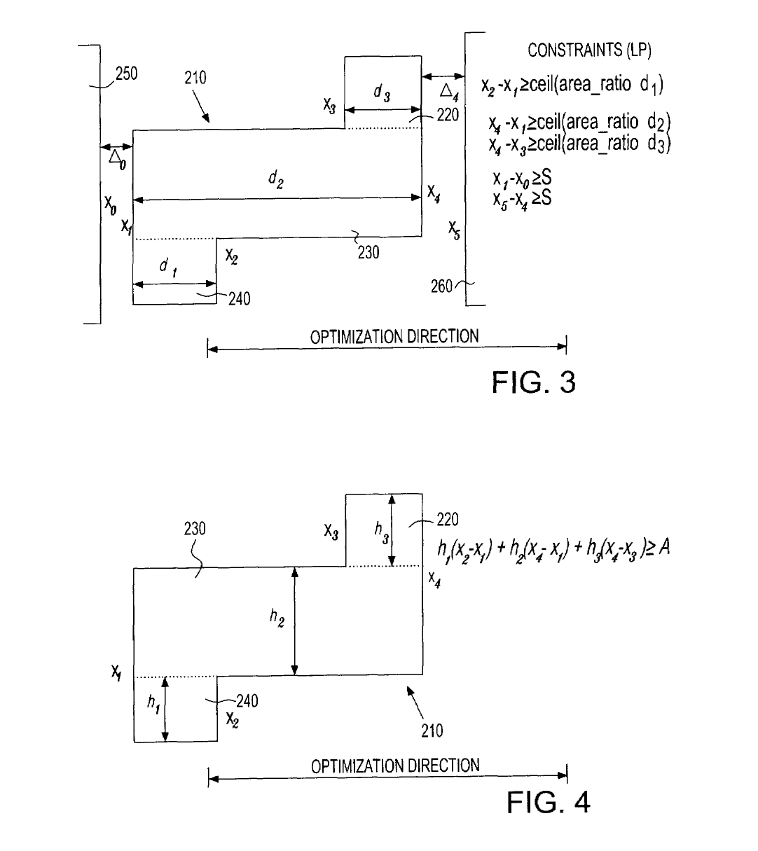

FIG. 3 shows polygon 210, as modified into rectangles 220, 230 and 240, and also including two neighboring shapes, 250 and 260, respectively, on the left most and right most portions of the figure, respectively. FIG. 3 also shows the linear programming constraints for each rectangle 220, 230, 240 (to the right of neighboring shape 260), which constraints are built or calculated using the area ratio and the current rectangular distances. The calculation includes determining a ceiling of the right-hand side (RHS) of the constraints to ensure a half-integer result. The FIG. 3 arrangement, the restraints require that:

x₂−x₁≧ceil((area ratio)*d₁);

x₄−x₁≧ceil((area ratio)*d₂);

x₄−x₃≧ceil((area ratio)*d₃);

x₁−x₀≧S;

x₅−x₄≧S;

where S is a minimum spacing value used to demonstrate environmental constraints influencing the polygon modification, migration, compaction, etc.

Each equation in the system of equations (i.e., the LP problem solution), for example, as shown in FIG. 3, includes two variables. By use of the only two variables, a half-integer solution is realized and solved using the aforementioned method. And while the novel first approach works well for most polygonal shapes operated upon, particular shapes may need further or different processing. That is, some shapes may require modification that is not proportional throughout the shape.

Hence, a second approach for polygonal area legalization of the invention will now be explained with reference to FIG. 4, that deals with less proportional polygons that have violated design rules. FIG. 4 shows a polygon 210 that is an object in a VLSI circuit design layout, and which violates design rules. The inventive method partitions the area of polygon 210 into three separate rectangles, with three separate heights, h₁, h₂ and h₃. The optimization direction is along the width of the plane of the drawing figure, which is the “x” or abscissa axis. The dotted lines are partition lines inserted by the inventive method, where the solid lines define the original polygon boundaries. The boundaries include side x₁, side elevations x₂ and X₃, and side x₄.

The second approach or method provides that each portion of a polygon is adjusted independently, in order to avoid violating, or to satisfy the area rule or constraint. Doing so requires formulating and solving the linear programming (LP) problem differently than that described in relation to the FIG. 3 embodiment. That is, the FIG. 4 embodiment accounts for portions of polygon 210 to be modified more independently, or disproportionately, where necessary, including implementing maximum area constraints and preserving the hierarchy, and the original design intent. The area constraint equations are formulated for the three distinct portions of polygon 210, using the edges as variables. The sum of the three areas of the partitioned rectangles is calculated by the method to be greater than or equal to a calculated value A, where A is the minimal polygonal area rule value.

To avoid violating the minimal polygonal area rule value, A must be less than or equal to the sum of the areas or the three rectangles. That is:

h₁(x₂−x₁)+h₂(x₄−x₁)+h₃(x₄−x₃)≧A,

where hₙ variables are constant in the exemplary optimization direction shown. The present invention solves the constraint equation in a global optimization.

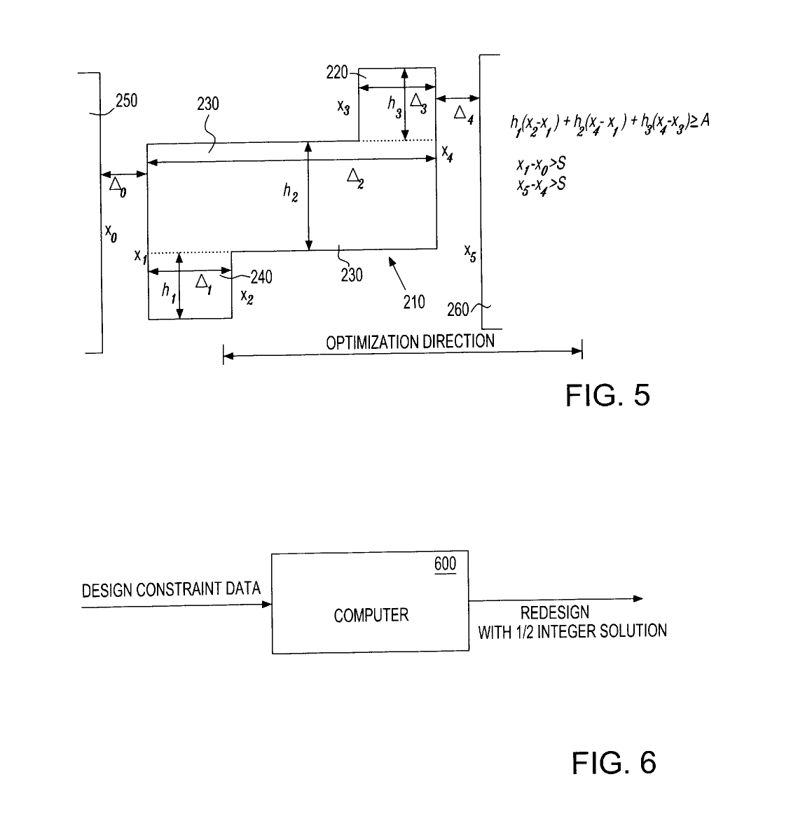

FIG. 5 shows polygon 210 (introduced in FIG. 2) constrained in the optimization direction as against its neighbor polygons 250 and 260. “S” is a minimum spacing value used in two additional objectives, which demonstrate environmental constraints influencing the polygon. The minimum spacing objectives with respect to the minimal polygonal area rule value, A, include:

x₁−x₀≧s; and

x₅−x₄≧s.

But since the area objective equation contains more than two variables, the solution may not be integral. Hence the layout modification requires that the edge locations must be representable by integers. The invention converts the linear programming problem containing area constraints with more than two variables to a linear programming problem where all of the constraints contain two variables. Doing so requires implementing a minimum perturbation objective, which minimizes movement of layout edges. The inventive method is not limited to implementing the minimum perturbation objective, but may implement any objective available and known, for example, compaction.

That is, the method requires solving a linear programming problem, LP1, to obtain solution [x₀′, x₁′, x₂′, x₃′, x₄′, x₅′]. In every area constraint with more than two variables, the method includes using the solution LP1 to replace one of the difference terms with an integer constant to formulate a new LP problem, LP2. LP2 is formulated as follows:

Let Δ₁′=f(x₂′−x₁′), where f:IR→Z, such as: round, floor, ceil, etc.

The new LP problem, LP2, is formulated using Δ1′, such that

h₁Δ1′+h₂(x4−x₁)+h₃(x₄−x₃)≧A

x₂−x₁≧Δ1′

x₁−x₀≧s

x₅−x₄≧s,

where the area constraint has four variables, as distinguished from six. The method then solves LP2 to obtain solution [x₀″, x₁″, x₂″, x₃″, x₄″, x₅″], wherein each area constraint with more than two variables use the solution LP2 to replace another difference term with an integer constant to formulate a new LP problem, LP3, as follows:

Let Δ₁″=f(x₂″−x₁″), and Δ₂″=f(x₄″−x₁″), where the new LP problem, LP3, is formulated using Δ₁″ and Δ₂″, such that

h₁Δ₁″+h₂Δ₂″+h₃(x₄−x₃)≧A

x₂−x₁≧Δ₁″

x₄−x₁≧Δ₂″

x₁−x₀≧s

x₅−x₄≧s.

The final step implemented before actually solving LP3 is to round RHS of the area constraints. If the constraint is minimum area, the ceiling of RHS is used, and if the constraint is maximum area, the floor of RHS is used.

x₄−x₃≧ceil((A−h₁Δ₁″−h₂Δ₂″)/h₃),

x₂−x₁≧Δ₁″

x₄−x₁≧Δ₂″

x1−x₀≧s

x₅−x₄≧s,

where the area constraint has two variables, as distinguished from four, and which can be readily solved using known techniques.

FIG. 6 is a representation of a general-purpose computer 600 that has been programmed to carry out the method by way of a set of computer instructions. The VLSI data to be operated upon by the inventive method is provided to the computer 600, which operates on the data in accordance with the method, and generates and outputs the re-design that redesigns shapes from the original layout in such a way that they do not violate a minimum area rule.

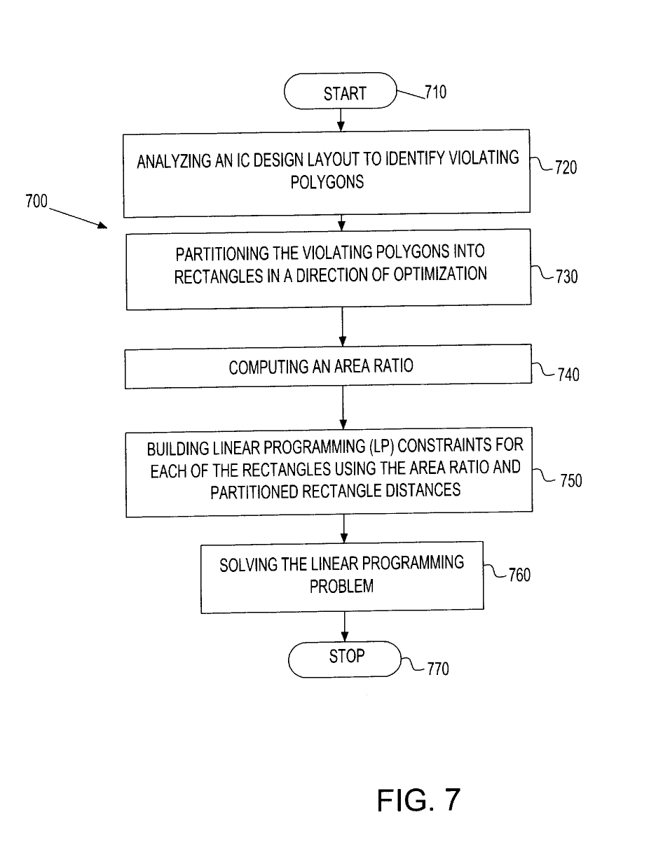

FIG. 7 is a flow chart 700 of one embodiment of a method for polygonal area design rule correction for use in an electronic design automation tool for governing integrated circuit (IC) design layouts using one-dimensional (1-D) optimization. As mentioned, the inventive method generates a very large-scale integrated (VLSI) circuit design that includes an automatic design rule correcting function. Block 710 indicates the start of the method. Block 720 indicates a step of analyzing an IC design layout data to identify violating polygons. Block 730 indicates a step of partitioning the violating polygons into rectangles in a direction of optimization. Block 740 indicates a step of computing an area ratio. Block 750 represents a step of building linear programming (LP) constraints for each of the rectangles using the area ratio and partitioned rectangle distances. Block 760 represents a step of solving an LP problem comprising the LP constraints, and block 770 indicates the end of the novel method.

As indicated hereinabove, it should be understood that the present invention could be realized in hardware, software, or a combination of hardware and software. Any kind of computer/server system(s)—or other apparatus adapted for carrying out the novel optimization methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, for example, the exemplary methods depicted in the figures herein, and which product—when loaded in a computer system—is able to carry out these and related methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A method for polygonal area design rule correction for use in an electronic design automation tool for governing integrated circuit (IC) design layouts using one-dimensional (1-D) optimization, comprising:
analyzing IC design layout data to identify polygons violating minimum or maximum area design rules;
partitioning the violating polygons into rectangles in a direction of optimization;
computing an area ratio;
building linear programming (LP) constraints of no more than two variables for each of the rectangles using the area ratio and partitioned rectangle distances; and
solving an LP problem comprising the LP constraints to proportionally adjust rectangle edge distances while maintaining the design layout hierarchy.

2. The method of polygonal area design rule correction as set forth in claim 1, wherein where maximum design constraints are implemented.

3. A computer program product that comprises a set of computer-readable instructions, which upon execution by a general purpose computer carries out the method for polygonal area design rule correction as set forth in claim 1.

4. The method of polygonal area design rule correction as set forth in claim 1, wherein the step of partitioning includes proportionally adjusting an edge distance of each rectangle by the same ratio in order that the total area of the offending polygons and shapes meet a minimum area rule.

5. A method of polygonal area design rule correction for use in an electronic design automation tool for governing integrated circuit (IC) design layouts using one-dimensional (1-D) optimization, comprising:
analyzing IC design layout data to identify polygons violating minimum or maximum area design rules;
partitioning violating polygons into rectangles in a direction of optimization;
formulating an area constraint for each violating polygon to formulate a global linear programming (LP) problem; and
solving the global LP problem to obtain a real-valued solution while maintaining the IC design layout's original hierarchy.

6. The method of polygonal area design rule correction as set forth in claim 5, further comprising the steps of:
creating a next LP problem for each area constraint in the global LP problem;
solving the next LP problem; and
repeating the steps of creating a next LP problem, and solving the next LP problem until the last next LP problem solved comprises constraints and objectives representing sums or differences of no more than two optimization variables.

7. The method of polygonal area design rule correction as set forth in claim 5, wherein the step of solving further includes:
converting non-integers to integers where necessary, to replace one of the difference terms with an integer constant; and
adding a new constraint row in which the row's left hand side includes the difference term replaced with said integer constant, where the row's right hand side is the integer constant.

8. The method of polygonal area design rule correction as set forth in claim 5, further including solving for remaining difference terms in each area constraint having two optimization variables, and using a ceiling of the right hand side where:
the constraint is minimum area; or
the floor of the right hand side if the constraint is maximum area; and
creating and solving a final LP problem to obtain a half-integer solution.

9. The method of polygonal area design rule correction as set forth in claim 5, wherein LP program structure is reduced to two variables, whereby a half-integer solution is realized.

10. The method of polygonal area design rule correction as set forth in claim 5, where maximum design constraints are implemented.

11. A computer program product that comprises a set of computer-readable instructions, which upon execution by a general purpose computer carries out the method of polygonal area design rule correction as set forth in claim 5.

12. A computer system for optimizing a very large scale integrated (VLSI) circuit design layout by implementing an orthogonal polygonal area design rule correcting function for solving maximum/minimum polygonal area violations, the computer system including computer means for executing the method as set forth in claim 5.

13. A computer system for optimizing a very large scale integrated (VLSI) circuit design layout by implementing an orthogonal polygonal area design rule correcting function for solving maximum/minimum polygonal area violations, the computer system comprising:
computer means for receiving a set of data comprising the VLSI circuit design layout;
computer means for identifying polygonal design rule violations in the design layout wherein physical layout edges are represented as variables; and
computer means for partitioning identified violating polygons into rectangles in a direction of optimization in the layout, which partitioning includes proportionally adjusting edge distances of each rectangle by a calculated fixed ratio in order that a total area of the offending polygons and shapes meet a minimum area rule;
computer means for generating a linear programming (LP) problem structure comprising a set of constraints defined by no more than two variables and modeled on design rules driving from a calculated ratio of desired polygonal area to measured polygonal area;
computer means for solving the LP problem to realize half-integer solutions.

14. The system as set forth in claim 13, wherein the means for generating provides that the LP constraints are generated for each rectangle using the minimum area ratio and measured distances between the rectangles in order to ensure half-integer solutions to the LP problem generated and solved to realize half-integer solutions.
